(19) United States
(12) Patent Application Publication
(10) Pub. No.: US 2019/0107987 A1
(43) Pub. Date: Apr. 11, 2019

(54) AUTOMATED CONFIGURATION OF MULTIPLE COLLABORATION ENDPOINTS

(71) Applicant: Cisco Technology, Inc., San Jose, CA (US)

(72) Inventors: Kristian Tangeland, Oslo (NO); Oystein Birkenes, Oslo (NO); Michael Elliott Jones, Oslo (NO); Linn Tale Haugen, Oslo (NO); Jon Dalvang Andresen, Oslo (NO)

(21) Appl. No.: 15/729,160

(22) Filed: Oct. 10, 2017

(51) Int. Cl. G06F 3/147; H04L 29/08; H04L 12/24; G06F 3/14

(52) U.S. Cl. CPC G06F 3/147; H04L 67/18; H04W 4/023; H04L 67/36; G06F 3/1446; H04L 41/0886

(57) ABSTRACT

A computer-implemented method including at a server in communication with at least first and second collaboration endpoints each located within a same physical space: determining a relative positioning of the first and second collaboration endpoints; and configuring content displayed at each of the first and second endpoints based on the relative positioning of the first and second collaboration endpoints is disclosed.

### TECHNICAL FIELD

This disclosure is generally related to the automated configuration of the content displayed at multiple collaboration endpoint displays within the same physical space.

### BACKGROUND

A collaboration endpoint is a computing device (e.g., video conferencing unit) designed to facilitate online meetings/conferences, and which includes at least a display screen and one or more cameras. In certain collaboration spaces (e.g., meeting/conference rooms), multiple collaboration endpoints may be present and movable. Multiple, movable collaboration endpoints within a collaboration space facilitate various collaboration activities, such as roundtable meetings, stand up meetings, brainstorming, problem solving, etc. While combining multiple collaboration endpoints in a single space may support advanced collaboration scenarios, complexities of coordinating content (e.g., video, images, audio, notifications, presentations, etc.) between the multiple collaboration endpoints may impede workflow.

### BRIEF DESCRIPTION OF THE DRAWINGS

FIG. 1 is a block diagram illustrating a system for configuring the display of content at multiple collaboration endpoints, according to an example embodiment.

FIG. 2 is a block diagram of a collaboration endpoint, according to an example embodiment.

FIG. 3 is a schematic diagram illustrating two collaboration endpoints within a collaboration space, according to an example embodiment.

FIG. 4 is a schematic diagram illustrating two collaboration endpoints within a collaboration space, according to an example embodiment.

FIG. 5 is a schematic diagram illustrating two collaboration endpoints within a collaboration space, according to an example embodiment.

FIG. 6 is a schematic diagram illustrating two collaboration endpoints within a collaboration space, according to an example embodiment.

FIGS. 7A, 7B, 7C, and 7D are timelines of time division duplex (TDD) signals transmitted to and received at collaboration endpoints, according to an example embodiment.

FIGS. 8A, 8B, 8C, and 8D are timelines of frequency division duplex (FDD) and code division duplex (CDD) signals transmitted to and received at collaboration endpoints, according to an example embodiment.

FIG. 9 is a schematic diagram illustrating two collaboration endpoints positioned parallel to each other and within a predetermined relative proximity, according to an example embodiment.

FIGS. 10A and 10B are schematic diagrams illustrating a determination of whether two collaboration endpoints are located within a predetermined relative proximity, according to an example embodiment.

FIG. 11 is a schematic diagram illustrating two collaboration endpoints positioned parallel to each other and within a predetermined relative proximity, according to an example embodiment.

FIGS. 12A and 12B are schematic diagrams illustrating a determination of whether two collaboration endpoints are located within a predetermined relative proximity, according to an example embodiment.

FIG. 13 is a block diagram of collaboration endpoint including an indoor localization transceiver, according to an example embodiment.

FIG. 14A illustrates a high-level flowchart illustrating a method to carry out an example embodiment, according to an example embodiment.

FIG. 14B illustrates a flowchart for an operation illustrated in FIG. 14A, according to an example embodiment.

FIG. 15 is a block diagram of a server configured to perform content configuration techniques, according to an example embodiment.

### DESCRIPTION OF EXAMPLE EMBODIMENTS

### Overview

Presented herein are techniques for automatically configuring the content displayed at multiple collaboration endpoints located in the same physical space. More specifically, in accordance with the techniques presented herein, the multiple collaboration endpoints each include a display screen and are connected to a server. The server is configured to determine a relative positioning of the multiple collaboration endpoints (i.e., determine the position of the multiple collaboration endpoints with respect to one another within the physical space). The content displayed at the display screens of the collaboration endpoints is automatically set/configured based on the relative positioning of the multiple collaboration endpoints.

### Example Embodiments

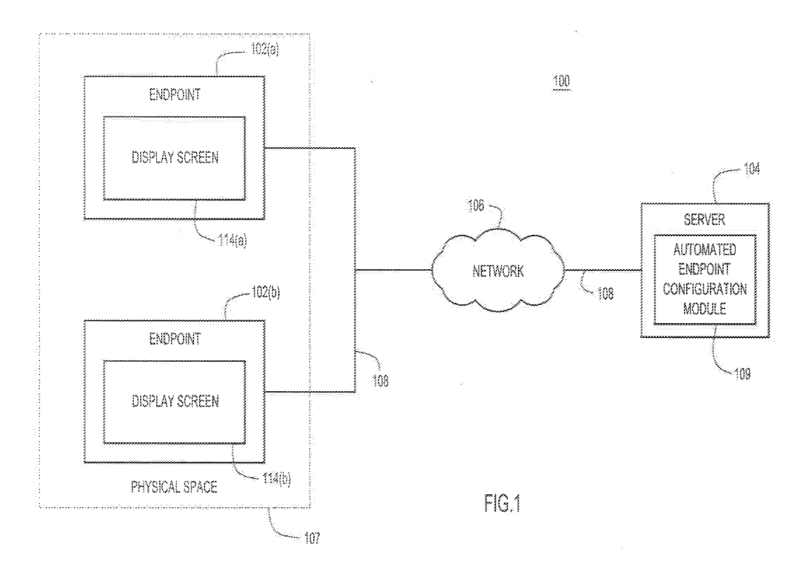

Turning first to FIG. 1, shown is a system 100 for automatically configuring the content displayed at multiple collaboration endpoints, according to an example embodiment. For ease of illustration, FIG. 1 illustrates two collaboration endpoints 102(a) and 102(b). However, it is to be appreciated that the techniques presented herein may be implemented in systems that include more than two collaboration endpoints.

The two collaboration endpoints 102(a) and 102(b) are connected to a server 104 via a network 106. The network 106 may be a local area network (LAN), a wireless local area network (WLAN), a wide area network (WAN), or a metropolitan area network (MAN), etc. As shown, each of collaboration endpoint 102(a), collaboration endpoint 102(b), and the server 104 are connected to the network 106 via a respective communication link 108. In another embodiment, at least one of the endpoints 102(a) and 102(b) may perform the functions of the server 104. The communication links 108 may be wired communication links, wireless communication links, or a combination of wired and wireless communication links.

The collaboration endpoints 102(a) and 102(b) are located within the same physical space 107, sometimes referred to herein as a “collaboration space.” The physical space 107 may be, for example, a conference room, a meeting room, a team room, a project space, a workshop area, etc. The collaboration endpoint 102(a) includes a display screen 114(a), while the collaboration endpoint 102(b) includes a display screen 114(b). As described further below, the collaboration endpoints 102(a) and 102(b) may be standalone collaboration endpoints that include hardware enabling interoperation with one another (i.e., with the other collaboration endpoint).

The server 104 includes an automated endpoint configuration module 109 that is configured to perform the endpoint configuration techniques presented herein. More specifically, the automated endpoint configuration module 109 is configured to determine a relative positioning of the multiple collaboration endpoints (i.e., determine the distance and orientation of the multiple endpoints with respect to one another within the physical space 107) and, based on the relative positioning of the multiple collaboration endpoints, automatically set/configure the content displayed at each of the display screens 114(a) and 114(b). The server 104 may also include hardware that facilitates interoperation of the two collaboration endpoints 102(a) and 102(b). One example hardware arrangement for the server 104 will be described below.

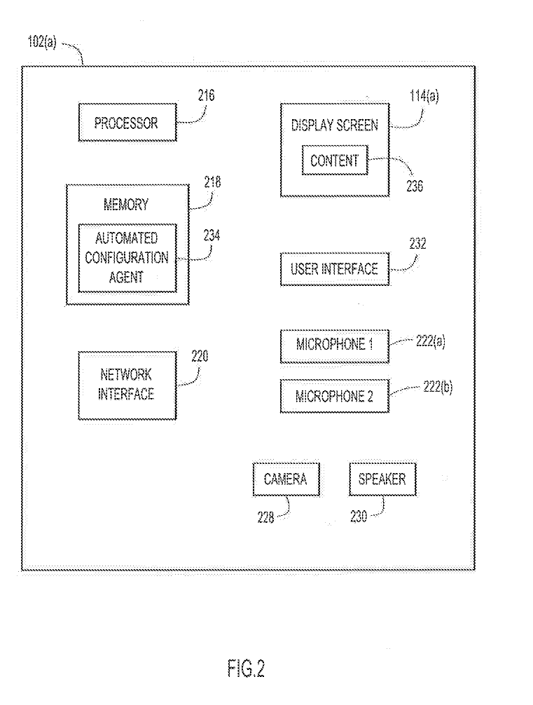

Turning to FIG. 2, shown is a block diagram of collaboration endpoint 102(a) of FIG. 1. Although FIG. 2 only illustrates an arrangement for collaboration endpoint 102(a), it is to be appreciated that collaboration endpoint 102(b) may have a similar arrangement. As such, the details of collaboration endpoint 102(b) have been omitted from the description.

As shown, collaboration endpoint 102(a) includes a processor 216, a memory 218, a network interface 220, one or more microphones 222, one or more cameras 228, a speaker 230, a user interface 232, and a display screen 114(a). The memory 218 includes an automated configuration agent 234.

The display screen 114(a) is an output device, such as a liquid crystal display (LCD), for presentation/display of visual information or “content” 236 to users located in the physical space 107. The content 236 displayed at the display screen 114(a) may comprise, for example, data content (e.g., a PowerPoint presentation, a portable document format (PDF) file, a Word document, etc.), video content (e.g., video from cameras captured at a remote collaboration endpoint), notifications (e.g., a notification that a new user has joined the collaboration session or an existing user has left the collaboration session), images, etc. While the display screen 114(a) is described in terms of displaying data content, video content, and notifications, it is to be appreciated that the content 236 may include various objects in various formats. Moreover, the content 236 may include the simultaneous display of multiple objects in multiple different formats.

The user interface 232 may take many different forms and may include, for example, a keypad, keyboard, mouse, touchscreen, etc. In certain examples in which the user interface 232 is a touchscreen, the display screen 114(a) and the user interface 232 may be integrated as a single unit that both accepts inputs from a user of the collaboration endpoint 102(a) and displays content 236.

In the example of FIG. 2, the one or more microphones 222 comprise a first microphone 222(a) and a second microphone 222(b). The two microphones 222(a) and 222(b) are devices that are configured to detect acoustic signals (e.g., voices of persons within the physical space 107) and to convert the acoustic signals into electrical signals. In certain examples described further below, the two microphones 222(a), 222(b) may be used to detect acoustic signals transmitted from other collaboration endpoints, such as collaboration endpoint 102(b). While two microphones are described in FIG. 2, any number of microphones may be used in the collaboration endpoint 102(a).

The collaboration endpoint 102(a) also comprises a camera 228. The camera 228 is a device configured to capture and/or record video, such as video of persons in the physical space 107. As described further below, the camera 228 may also be used to detect location of persons within the physical space 107

The memory 218 includes an automated configuration agent 234. As described further below, the automated configuration agent 234 may be executed by the processor 216 to perform measurements that enable the server 104 (FIG. 1) to determine the relative positioning of endpoints 102(a) and 102(b). The memory 218 may comprise any one or more of read only memory (ROM), random access memory (RAM), magnetic disk storage media devices, optical storage media devices, flash memory devices, electrical, optical, or other physical/tangible memory storage devices. The one or more processors 216 are, for example, microprocessors or microcontrollers that execute instructions for the automated configuration agent 234 stored in memory 218.

The collaboration endpoint 102(a) may also include a network interface 220. The network interface 220 enables the collaboration endpoint 102(a) to transmit and receive network communications. For example, the network interface 220 enables the collaboration endpoint 102(a) to transmit network traffic to the server 104 via the network 106 and communication links 108. Additionally, the network interface 220 may enable the collaboration endpoint 102(a) to receive network traffic from the server 104 via the network 106 and communication links 108.

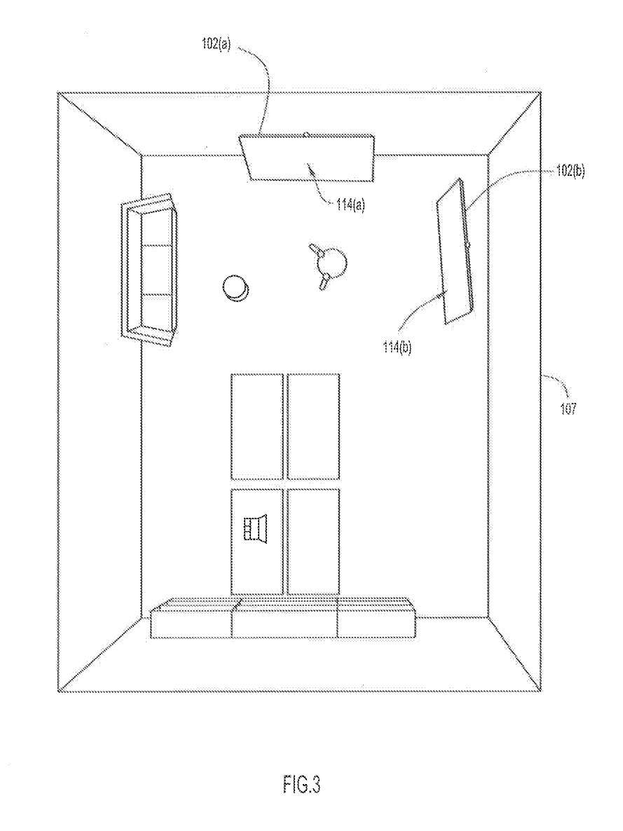

Turning to FIG. 3, with continued reference to FIGS. 1 and 2, shown is a schematic view of the physical space 107 having the collaboration endpoints 102(a) and 102(b) located therein. The collaboration endpoints 102(a) and 102(b) include display screens 114(a) and 114(b), respectively. The collaboration endpoints 102(a) and 102(b) each also include an automated configuration agent 234.

The automated configuration agent is configured to perform one or more measurements that enable server 104 to determine a relative positioning of the collaboration endpoints 102(a) and 102(b) (i.e., to determine the distance between the collaboration endpoints 102(a) and 102(b) and the orientation of the collaboration endpoints 102(a) and 102(b) with respect to one another within the physical space 107)).

After the automated configuration agents perform the measurements, the measurement data (i.e., the data gathered as a result of the measurements) is sent to the server 104. Based on the measurement data, the automated endpoint configuration module 109 of the server 104 may be configured to determine a distance between portions of the collaboration endpoints 102(a), 102(b). The automated endpoint configuration module 109 may also be configured to determine a relative orientation of the collaboration endpoints 102(a) and 102(b) (i.e., the orientation of the collaboration endpoints with respect to one another). Techniques to determine the distance between, and the relative orientations of the collaboration endpoints 102(a) and 102(b), are described in more detail below.

In the specific example of FIG. 3, the automated endpoint configuration module 109 determines that the collaboration endpoints 102(a) and 102(b) are located within a predetermined distance from one another (i.e., are located within a predetermined proximity, such as five feet, ten feet, etc.) and that the display screens 114(a) and 11(b) of the collaboration endpoints 102(a) and 102(b) are oriented substantially orthogonal/perpendicular to each other. Based on this determined orientation, the automated endpoint configuration module 109 may determine a configuration of content 236 to be displayed on the display screens 114(a), 114(b) of the collaboration endpoints 102(a), 102(b). The server 104 may transmit the configuration of content 236 to each of the collaboration endpoints 102(a), 102(b). At the collaboration endpoints 102(a), 102(b), the respective automated configuration agent may configure the respective display screens 114(a), 114(b) based on the configuration received from the server 104.

As noted above, the server 104 determines that the collaboration endpoints 102(a), 102(b) are positioned within a predetermined relative proximity to each other (e.g., within 5 feet of one another, within 10 feet of one another, etc.). The relative proximity may be a default value, a user defined value, etc. In one example, a user may set the predetermined relative proximity, or change the default predetermined relative proximity, by entering a value at one of the collaboration endpoints 102(a), 102(b) or the server 104. When the two collaboration endpoints 102(a), 102(b) are positioned within the predetermined relative proximity, the display screens 114(a), 114(b) of the two collaboration endpoints 102(a), 102(b) may operate as a combined/connected (i.e., a single and linked) display screen. For example, a user of the two collaboration endpoints 102(a), 102(b) in FIG. 3 may drag from display screen 114(a) to display screen 114(b) a window containing, for example, a presentation. Because the display screens 114(a), 114(b) of the two collaboration endpoints 102(a), 102(b) are operating as a combined display screen, the user would be able to move the window from display screen 114(a) to display screen 114(b).

Further, FIG. 3 illustrates that the two collaboration endpoints 102(a), 102(b) are oriented substantially orthogonal to each other. This orientation may be used in, for example, a standup meeting or an ad hoc content collaboration session. In this orientation, new or updated content 236, such as a presentation, video, and notifications, etc., may be provided for display at one of the collaboration endpoints 102(a) or 102(b). In accordance with examples presented herein, the new or updated content 236 may be displayed at a selected one of the display screens 114(a) or 114(b).

Selection of a display screen 114(a) or 114(b) for display of new or updated content 236 may be based on various criteria. For example, one criteria may be a proximity/location of the local users with respect to the two collaboration endpoints 102(a), 102(b). For example, the respective cameras of the two collaboration endpoints 102(a), 102(b) may determine a distance between the location of the local users and the collaboration endpoints. The collaboration endpoints 102(a), 102(b) may transmit this distance to the server 104 where the automated endpoint configuration module 109 may determine a preferred display screen for use in displaying the new or updated content 236. In certain examples, the display screen of the collaboration endpoint that is located in closest proximity to the users may be selected for use in displaying the new or updated content 236.

In other examples, the criteria for selection Of a display screen 114(a) or 114(b) for display of new or updated content 236 may be the number of interactions the local users have had with the collaboration endpoints 102(a), 102(b) (e.g., interactions keypad, keyboard, mouse, touch screen, etc.). The automated configuration agents at the collaboration endpoints 102(a) and 102(b) may then transmit the interaction data to the server 104. Based on the interaction data, the automated endpoint configuration module 109 may determine the collaboration endpoint that has had the most interactions with the local users should be selected to display screen the new or updated content 236.

In another aspect, the criteria for selection of a display screen 114(a) or 114(b) for display of new or updated content 236 may be the gaze of the users within the physical space (i.e., the direction in which the users are looking). In these examples, the automated configuration agents at the collaboration endpoints 102(a) and 102(b) may determine the direction in which the users are looking using for example, the cameras at the collaboration endpoints 102(a) and 102(b). The collaboration endpoints 102(a), 102(b) may then transmit the gaze data to the server 104. The automated endpoint configuration module 109 may then use the gaze data to determine that the collaboration endpoint that the local users are looking at should be selected to display the new or updated content 236.

In another aspect, the criteria for selection of a display screen 114(a) or 114(b) for display of new or updated content 236 may be least-occupied collaboration endpoint. In these examples, the automated endpoint configuration module 109 may determine which one of the collaboration endpoints 102(a), 102(b) is not currently displaying content and/or is displaying less content. In such examples, the automated endpoint configuration module 109 may determine that the display screen of collaboration endpoint that is not currently displaying content (or which is displaying less content) should be selected to display the new or updated content 236.

At least one of the collaboration endpoints 102(a), 102(b) may display video at the respective display screen 114(a), 114(b). The operation of the collaboration endpoints 102(a), 102(b) when displaying video may differ based on attributes of the video. For example, when a local user initiates a video conference call on a collaboration endpoint, such as collaboration endpoint 102(a), a remote user of the video conference call may appear on the collaboration endpoint on which the video conference call was made (i.e., collaboration endpoint 102(a)). In another aspect, when a remote user joins a scheduled collaboration session, the remote user may be displayed on the collaboration endpoint with the least-occupied display screen. For example, if the display screen 114(a) of collaboration endpoint 102(a) is being used to display a presentation while the display screen 114(b) of collaboration endpoint 102(b) is not displaying content 236, then the remote user may be shown on the display screen 114(b) of collaboration endpoint 102(b) because it is the least-occupied display screen. Additionally, microphones 222, a camera 228, and speaker 230 may follow the collaboration endpoint 102(a), 102(b) that displays the remote user, here collaboration endpoint 102(b).

As described above, because the collaboration endpoints 102(a), 102(b) are within a predetermined relative proximity in this example, the display screens 114(a), 114(b) of collaboration endpoints 102(a), 102(b) operate as a combined display screen. Accordingly, data content shown on collaboration endpoint 102(a), for example, may be dragged and shown on collaboration endpoint 102(b). Moreover, the relative positions of the collaboration endpoints 102(a), 102(b) may be used to determine a left display screen and a right display screen, for example. In FIG. 3, collaboration endpoint 102(a) may include the left display screen 114(a) and collaboration endpoint 102(b) may include the right display screen 114(b). If, during a collaboration session, the relative positions of the collaboration endpoints 102(a), 102(b) change, the automated endpoint configuration module 109 may reconfigure the two collaboration endpoints 102(a), 102(b). For example, if the position of the collaboration endpoints 102(a), 102(b) in FIG. 3 were switched, then the automated endpoint configuration module 109 may reconfigure collaboration endpoint 102(a) to include the right display screen 114(a) and reconfigure collaboration endpoint 102(b) to include the left display screen 114(b).

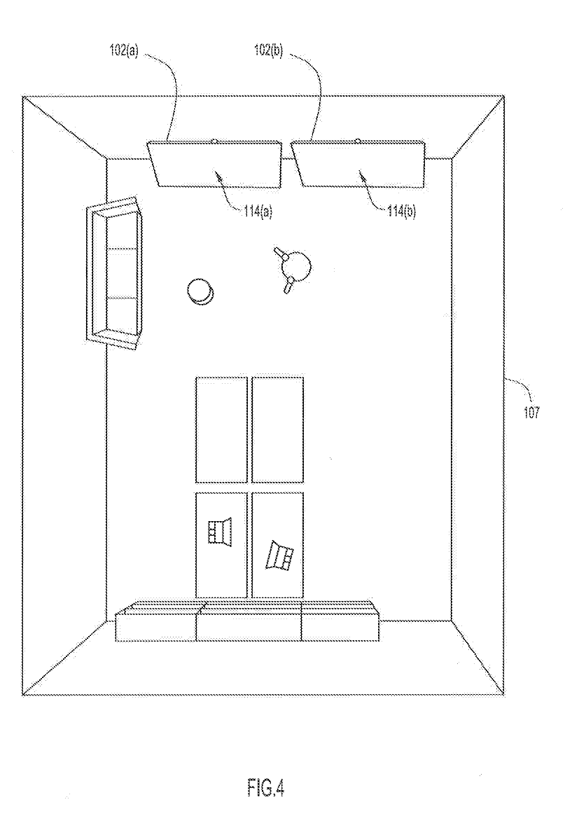

Turning next to FIG. 4, with continued reference to FIGS. 1 and 2, shown is a schematic view of the physical space 107 having the collaboration endpoints 102(a), 102(b) located therein. As shown, noted above, the collaboration endpoints 102(a) and 102(b) include display screens 114(a) and 114(b), respectively. The collaboration endpoints 102(a) and 102(b) each also include an automated configuration agent 234.

As described above, the collaboration endpoints 102(a) and 102(b) each include an automated configuration agent that is configured to perform one or more measurements that enable server 104 to determine a relative positioning of the collaboration endpoints 102(a) and 102(b) to determine the distance between the collaboration endpoints 102(a) and 102(b) and the orientation of the collaboration endpoints 102(a) and 102(b) with respect to one another within the physical space 107)).

After the automated configuration agents perform the measurements, the measurement data (i.e., the data gathered as a result of the measurements) is sent to the server 104. Based on the measurement data, the automated endpoint configuration module 109 of the server 104 may be configured to determine a distance between portions of the collaboration endpoints 102(a), 102(b). The automated endpoint configuration module 109 may also be configured to determine a relative orientation of the collaboration endpoints 102(a) and 102(b) (i.e., the orientation of the collaboration endpoints with respect to one another). Techniques to determine the distance between, and the relative orientations of the collaboration endpoints 102(a) and 102(b), are described in more detail below.

In the specific example of FIG. 4, the automated endpoint configuration module 109 running on the server 104 determines that the collaboration endpoints 102(a) and 102(b) are located within a predetermined distance from one another are located within a predetermined proximity, such as five feet, ten feet, etc.) and that the display screens 114(a) and 11(b) of the collaboration endpoints 102(a) and 102(b) are oriented substantially parallel to each other. Based on this orientation, the automated endpoint configuration module 109 may determine a configuration of content 236 to be displayed on the display screens 114(a), 114(b) of the collaboration endpoints 102(a), 102(b). The server 104 may transmit the configuration of content 236 to each of the collaboration endpoints 102(a), 102(b). At the collaboration endpoints 102(a), 102(b), the respective automated configuration agent may configure the respective display screens 114(a), 114(b) based on the configuration received from the server 104. Because the two collaboration endpoints 102(a), 102(b) are positioned within the predetermined relative proximity to each other, the display screens 114(a), 114(b) of collaboration endpoints 102(a), 102(b) may operate as a combined display screen, as described above in connection with FIG. 3.

Further, FIG. 4 illustrates that the two collaboration endpoints 102(a), 102(b) are oriented substantially parallel to each other. This orientation may be used in, for example, a presentation collaboration session. In this orientation, new or updated content 236, such as a presentation, video, and notifications, etc. may be provided for display at one of the collaboration endpoints 102(a) or 102(b). In one example, local users of the collaboration endpoints 102(a), 102(b) in this positioning may not notice new or updated content 236 on a display screen of which the local users are not in front. Therefore, in accordance with examples presented herein, the new or updated content 236 may be displayed at the display screen of which the local users are in front.

Selection of a display screen 114(a) or 114(b) for display of new or updated content 236 may be based on various criteria. For example, the criteria described above in connection with FIG. 3 may also be used in this positioning. Additionally, selection of a display screen that the local users are in front of may be accomplished in a number of ways. For example, the automated endpoint configuration module 109 may use face detection schemes, motion detection schemes, speaker tracking schemes, etc.

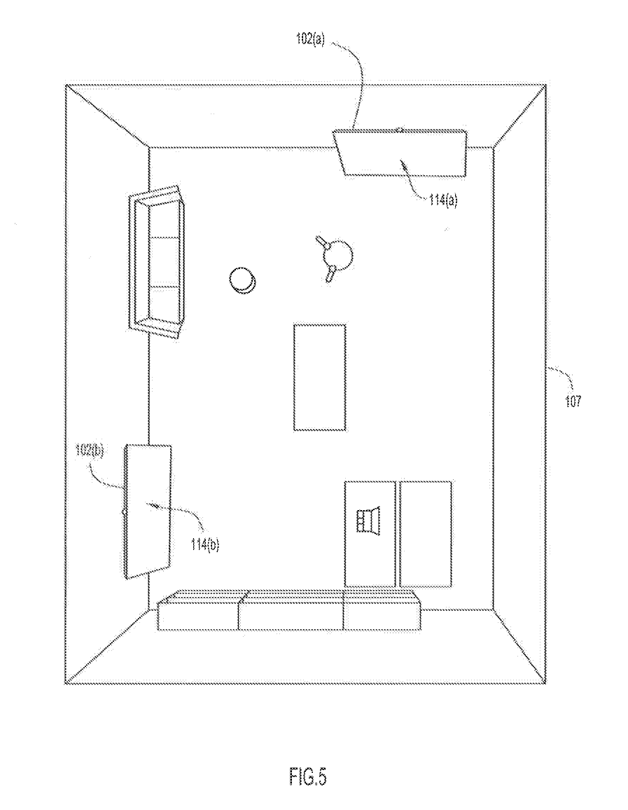

Turning next to FIG. 5, with continued reference to FIGS. 1 and 2, shown is a schematic view of the physical space having the collaboration endpoints 102(a) and 102(b) located therein. The collaboration endpoints 102(a) and 102(b) include display screens 114(a) and 114(b), respectively. The collaboration endpoints 102(a) and 102(b) each also include an automated configuration agent 234.

As described above, the automated configuration agent is configured to perform one or more measurements that enable server 104 to determine a relative positioning of the collaboration endpoints 102(a) and 102(b) (i.e., to determine the distance between the collaboration endpoints 102(a) and 102(b) and the orientation of the collaboration endpoints 102(a) and 102(b) with respect to one another within the physical space 107)).

After the automated configuration agents perform the measurements, the measurement data (i.e., the data gathered as a result of the measurements) is sent to the server 104. Based on the measurement data, the automated endpoint configuration module 109 of the server 104 may be configured to determine a distance between portions of the collaboration endpoints 102(a), 102(b). The automated endpoint configuration module 109 may also be configured to determine a relative orientation of the collaboration endpoints 102(a) and 102(b) (i.e., the orientation of the collaboration endpoints with respect to one another). Techniques to determine the distance between, and the relative orientations of the collaboration endpoints 102(a) and 102(b), are described in more detail below.

In the specific example of FIG. 5, the automated endpoint configuration module 109 determines that the collaboration endpoints 102(a) and 102(b) are not located within a predetermined distance from one another (i.e., are located within a predetermined proximity, such as five feet, ten feet, etc.). Based on this positioning, the automated endpoint configuration module 109 may determine a configuration of content 236 to be displayed on the display screens 114(a), 114(b) of the collaboration endpoints 102(a), 102(b). The server 104 may transmit the configuration of content 236 to each of the collaboration endpoints 102(a), 102(b). At the collaboration endpoints 102(a), 102(b), the respective automated configuration agent may configure the respective display screens 114(a), 114(b) based on the configuration received from the server 104.

When the two collaboration endpoints 102(a), 102(b) are positioned outside of the predetermined relative proximity, the display screens 114(a), 114(b) of collaboration endpoints 102(a), 102(b) may operate as two unrelated display screens 114(a), 114(b). For example, a video conference call may be taking place at one of the collaboration endpoints, such as collaboration endpoint 102(a). On collaboration endpoint 102(b), a presentation may be displayed. The video conference call at collaboration endpoint 102(a) and the presentation at collaboration endpoint 102(b) may be unrelated. For example, a topic of the video conference call may be unrelated to a topic of the presentation.

While the orientation of the two collaboration endpoints 102(a), 102(b) in FIG. 5 are orthogonal, the collaboration endpoints 102(a), 102(b) operate differently from the orthogonal collaboration endpoints 102(a), 102(b) in FIG. 3. This is because the collaboration endpoints 102(a), 102(b) in FIG. 5 are positioned outside of the predetermined relative proximity while the collaboration endpoints 102(a), 102(b) in FIG. 3 are positioned within the predetermined relative proximity.

The orientation of FIG. 5 may be used in, for example, a breakout session during a workshop. When the two collaboration endpoints 102(a), 102(b) are within the predetermined relative proximity and are then moved so that they are outside the predetermined relative proximity, at least one of the collaboration endpoints 102(a), 102(b) may prompt local users of the collaboration endpoints 102(a), 102(b) to decide whether the two collaboration endpoints 102(a), 102(b) should be temporarily dissociated from each other. This prompt may be caused by the collaboration endpoints 102(a), 102(b) receiving the configuration from the automated endpoint configuration module 109. If the local users decide to temporarily dissociate the two collaboration endpoints 102(a), 102(b) from each other, then the content 236 displayed on the display screens 114(a), 114(b) for each collaboration endpoint 102(a), 102(b) is unrelated to the other display screen.

When the two collaboration endpoints 102(a), 102(b) are outside the predetermined relative proximity and are then moved so that they are within the predetermined relative proximity, at least one of the collaboration endpoints 102(a), 102(b) may prompt local users of the collaboration endpoints 102(a), 102(b) to decide whether the two collaboration endpoints 102(a), 102(b) should be associated. This prompt may be caused by the collaboration endpoints 102(a), 102(b) receiving the configuration from the automated endpoint configuration module 109. If the local users decide that the two collaboration endpoints 102(a), 102(b) should be associated, then the display screens 114(a), 114(b) of the collaboration endpoints 102(a), 102(b) may operate as a combined display, as described above.

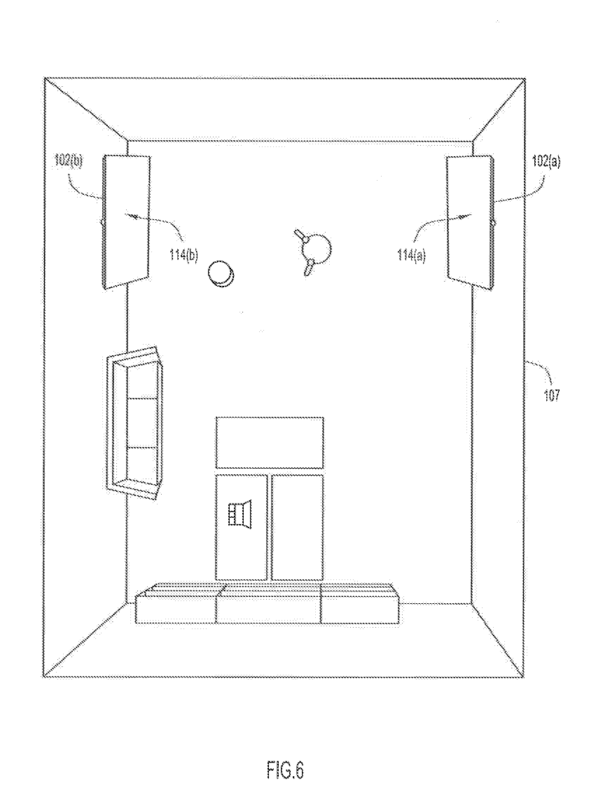

Turning next to FIG. 6, with continued reference to FIGS. 1 and 2, shown is a schematic view of the physical space 107 having the collaboration endpoints 102(a) and 102(b) located therein. The collaboration endpoints 102(a) and 102(b) include display screens 114(a) and 114(b), respectively. The collaboration endpoints 102(a) and 102(b) each also include an automated configuration agent 234.

The automated configuration agent is configured to perform one or more measurements that enable server 104 to determine a relative positioning of the collaboration endpoints 102(a) and 102(b) (i.e., to determine the distance between the collaboration endpoints 102(a) and 102(b) and the orientation of the collaboration endpoints 102(a) and 102(b) with respect to one another within the physical space 107)).

After the automated configuration agents perform the measurements, the measurement data (i.e., the data gathered as a result of the measurements) is sent to the server 104. Based on the measurement data, the automated endpoint configuration module 109 of the server 104 may be configured to determine a distance between portions of the collaboration endpoints 102(a), 102(b). The automated endpoint configuration module 109 may also be configured to determine a relative orientation of the collaboration endpoints 102(a) and 102(b) (i.e., the orientation of the collaboration endpoints with respect to one another). Techniques to determine the distance between, and the relative orientations of the collaboration endpoints 102(a) and 102(b), are described in more detail below.

In the specific example of FIG. 6, the automated endpoint configuration module 109 determines that the collaboration endpoints 102(a) and 102(b) are oriented so that the display screens 114(a), 114(b) are facing each other. Based on this orientation, the automated endpoint configuration module 109 may determine a configuration of content 236 to be displayed on the display screens 114(a), 114(b) of the collaboration endpoints 102(a), 102(b). The server 104 may transmit the configuration of content 236 to each of the collaboration endpoints 102(a), 102(b). At the collaboration endpoints 102(a), 102(b), the respective automated configuration agent may configure the respective display screens 114(a), 114(b) based on the configuration received from the server 104. This orientation may be used in, for example, a presentation or a review. Based on this orientation, the automated endpoint configuration module 109 may determine a configuration of content 236 of the collaboration endpoints 102(a), 102(b).

In operation, one of the collaboration endpoints, for example collaboration endpoint 102(a), may display at its display screen 114(a) remote participants of a collaboration session. Content 236, such as a presentation, may be displayed on the display screen 114(b) for collaboration endpoint 102(b). However, if the presenter is remote, the presenter and the content 236 may be displayed at the same display screen, in this case the display screen 114(b) for collaboration endpoint 102(b).

In one aspect, the collaboration endpoints 102(a), 102(b) do not have to be within a predetermined relative proximity to each other. However, a user of the system 100 or the server 104 may predetermine a maximum distance between the collaboration endpoints 102(a), 102(b) that enables the collaboration of FIG. 6. If the distance between the two collaboration endpoints 102(a), 102(b) exceeds this maximum distance, the two collaboration endpoints 102(a), 102(b) may operate as separate collaboration endpoints, as described above with reference to FIG. 5.

A number of different techniques may be used in the examples presented herein to determine the distance between collaboration endpoints 102(a) and 102(b), as well as the relative orientation of the collaboration endpoints 102(a) and 102(b). However, in accordance with examples presented herein, the collaboration endpoints 102(a) and 102(b) (i.e., automated configuration agents) are configured to perform one or more measurements and to provide the results of the measurements (i.e., the measurement data) to the server 104 for analysis.

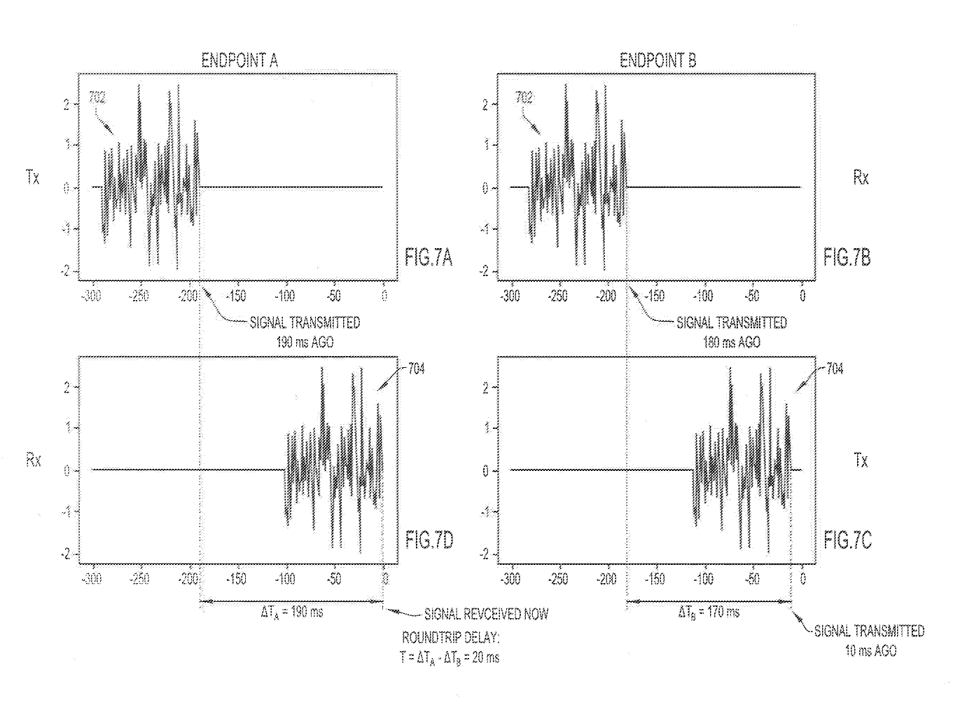

In certain examples, the collaboration endpoints 102(a) and 102(b) (i.e., automated configuration agents) are configured to measure a round trip distance of acoustic signals sent to and received from the collaboration endpoints 102(a), 102(b). The acoustic signals transmitted between the collaboration endpoints 102(a), 102(b) may be below a hearing threshold of humans (e.g., ultrasound signals). Additionally, the acoustic signals transmitted from collaboration endpoint 102(a) to collaboration endpoint 102(b) may be in a different communication channel from the acoustic signals transmitted from collaboration endpoint 102(b) to collaboration endpoint 102(a). In other words, the communication channel between the collaboration endpoints 102(a), 102(b) may be duplex. For example, three methods may be used to measure the round trip distance: time division duplex, frequency division duplex, and code division duplex. The automated endpoint configuration module 109 may use these distances to infer relative positions of the two collaboration endpoints 102(a), 102(b). Alternatively, instead of, or in addition to round trip distance, the collaboration endpoints 102(a), 102(b) may use impulse radio ultra-wideband (IR-UWB) technology to determine the relative positions of the two collaboration endpoints 102(a), 102(b). FIGS. 7A-13 illustrate further details of techniques for performing measurements at the collaboration endpoints 102(a) and 102(b) that generate measurement data for analysis by the server 104.

Referring first to FIGS. 7A, 7B, 7C, and 7D, shown are timelines of time division duplex (TDD) signals transmitted to, and received, at the collaboration endpoints 102(a), 102(b), according to examples presented herein. More specifically, FIG. 7A is a timeline of an acoustic signal 702 transmitted by collaboration endpoint 102(a). The acoustic signal 702 may be transmitted by speaker 230 of collaboration endpoint 102(a). In this example, the acoustic signal 702 has a duration of approximately 100 milliseconds (ms) and the acoustic signal 702 was transmitted by collaboration endpoint 102(a) approximately 290 ms before a current time. Since the acoustic signal 702 is approximately 100 ms in duration, the collaboration endpoint 102(a) terminated transmission of the acoustic signal 702 approximately 190 ms before the current time.

FIG. 7B is a timeline of the acoustic signal 702 transmitted from collaboration endpoint 102(a) being received at collaboration endpoint 102(b). In this example, the beginning of the acoustic signal 702 was received approximately 280 ms before the current time. Because the acoustic signal 702 has a duration of approximately 100 ms, the received acoustic signal 702 terminated 180 ms before the current time. The acoustic signal 702 may be received using, for example, at least one of microphones 222(a) or 222(b) of collaboration endpoint 102(b).

FIG. 7C is a timeline of an acoustic signal 704 transmitted by collaboration endpoint 102(b). In this example, the waveform of acoustic signal 702 sent by collaboration endpoint 102(a) is also the waveform of the acoustic signal 702 transmitted by collaboration endpoint 102(b). However, it should be appreciated that the acoustic signals transmitted by collaboration endpoints 102(a), 102(b) need not be the same. The acoustic signal 704 may be transmitted by speaker 230 of collaboration endpoint 102(b). In this example, collaboration endpoint 102(b) transmits the acoustic signal 704 after an approximately 70 ms delay. This delay may be attributable to, for example, a fixed known delay in the system and/or a buffer delay. In this example, the acoustic signal 704 has a duration of approximately 100 ms and the acoustic signal 704 was transmitted by collaboration endpoint 102(b) approximately 110 ms before the current time. Since the acoustic signal 704 is approximately 100 ms in duration, the collaboration endpoint 102(b) terminated transmission of the acoustic signal 704 approximately 10 ms before the current time.

FIG. 7D is a timeline of the acoustic signal 704 transmitted from collaboration endpoint 102(b) being received at collaboration endpoint 102(a). In this example, the beginning of the acoustic signal 704 was received approximately 100 ms before the current time. Because the acoustic signal 704 has a duration of approximately 100 ms, the received acoustic signal 704 terminated at the current time. The acoustic signal 704 may be received using, for example, at least one of microphones 222(a) or 222(b) of collaboration endpoint 102(a).

The respective automated configuration agents 234 of the collaboration endpoints 102(a), 102(b) may determine a time interval between a transmitted signal and a received signal. For example, in FIG. 7, at collaboration endpoint 102(a), the time interval may be the time collaboration endpoint 102(a) terminated transmitting the acoustic signal 702 and the time the received acoustic signal 704 at collaboration endpoint 102(a) terminated. In this example, this time interval is approximately 190 ms. At collaboration endpoint 102(b), the time interval may be the time collaboration endpoint 102(b) terminated receiving the acoustic signal 702 from collaboration endpoint 102(a) and terminated transmitting the acoustic signal 704 to collaboration endpoint 102(a). In this example, this time interval is approximately 170 ms.

The round trip delay may be determined from the time intervals. For example, the round trip delay may be a difference between the time intervals. In this example, the collaboration endpoints 102(a), 102(b) may transmit the time intervals to the server 104. The automated endpoint configuration module 109 at server 104 may determine the round trip delay between collaboration endpoints 102(a), 102(b) based on the time intervals. In this example, the round trip delay is approximately 20 ms (190 ms-170 ms). The round trip delay may be used to determine the distance between the collaboration endpoints 102(a), 102(b). In this example, a round trip delay of approximately 20 ms corresponds to a distance of approximately 6.8 meters.

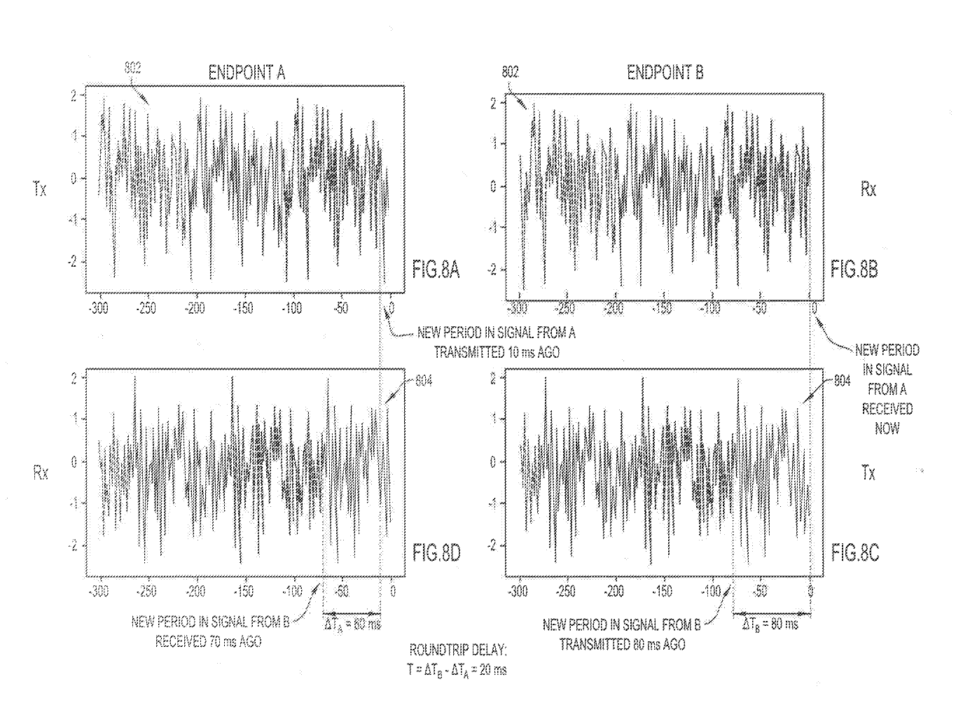

Turning next to FIGS. 8A, 8B, 8C, and 8D, shown are timelines of a frequency division duplex (FDD) signal transmitted to, and received, at the collaboration endpoints 102(a), 102(b), according to examples presented herein. It should be appreciated that code division duplex (CDD) signals may also be transmitted and received. More specifically, FIG. 8A is a timeline of an acoustic signal 802 transmuted by collaboration endpoint 102(a). The acoustic signal 802 may be transmitted by speaker 230 of collaboration endpoint 102(a). In this example, the acoustic signal 802 has a duration of approximately 100 ms and the acoustic signal 802 was transmitted by collaboration endpoint 102(a) approximately 10 ms before a current time. A new period of the acoustic signal 802 is indicated by dashed lines.

FIG. 8B is a timeline of the acoustic signal 802 transmitted from collaboration endpoint 102(a) being received at collaboration endpoint 102(b). In this example, the new period of the received acoustic signal 802 is received at approximately the current time. The acoustic signal 802 may be received using, for example, at least one of the microphones 222(a) or 222(b) collaboration endpoint 102(b). The beginning of a new period of the received acoustic signal 802 may be accurately detected in a variety of ways. For example, the collaboration endpoint 102(b) may use cross-correlation estimates.

FIG. 8C is a timeline of an acoustic signal 804 transmitted by collaboration endpoint 102(b). In this example, the waveform of the acoustic signal 802 sent by collaboration endpoint 102(a) is different from the waveform of the acoustic signal 804 transmitted by collaboration endpoint 102(b). In this example, which uses FDD, the acoustic signal 802 is in a different frequency band from the acoustic signal 804. In an example using CDD, the acoustic signal 802 is spread using a code different from the code used to spread acoustic signal 804. The acoustic signal 804 may be transmitted by speaker 230 of collaboration endpoint 102(b). In this example, collaboration endpoint 102(b) transmits the acoustic signal 804 approximately 80 ms before the current time.

FIG. 8D is a timeline of the acoustic signal 804 transmitted by collaboration endpoint 102(b) being received at collaboration endpoint 102(a). The acoustic signal 804 may be received using, for example, at least one of the microphones 222(a) or 222(b). In this example, the received acoustic signal 804 is received approximately 70 ms before the current time.

The respective automated configuration agents 234 of the collaboration endpoints 102(a), 102(b) may determine a time interval between a transmitted signal and a received signal. For example, in FIG. 8D, at collaboration endpoint 102(a), the time interval may be the time collaboration endpoint 102(a) started transmitting the acoustic signal 802 and the time the received acoustic signal 804 at collaboration endpoint 102(a) began. In this example, this time interval is approximately 60 ms. At collaboration endpoint 102(b), the time interval may be the time collaboration endpoint 102(b) started receiving the acoustic signal 802 from collaboration endpoint 102(a) and started transmitting the acoustic signal 804 to collaboration endpoint 102(a). In this example, this time interval is approximately 80 ms.

The round trip delay may be determined from the time intervals. For example, the round trip delay may be a difference between the time intervals. In this example, the collaboration endpoints 102(a), 102(b) may transmit the time intervals to the server 104. The automated endpoint configuration module 109 at server 104 may determine the round trip delay between collaboration endpoints 102(a), 102(b) based on the time intervals. In this example, the roundtrip delay is approximately 20 ms (80 ms-60 ms). The round trip delay may be used to determine the distance between the collaboration endpoints 102(a), 102(b). In this example, a roundtrip delay of about 20 ms corresponds to a distance of about 6.8 meters.

Common for the TDD, FDD, and CDD techniques is that clocks on collaboration endpoints 102(a), 102(b) need not be the same. This is so because each time interval is determined based on two timestamps at the same collaboration endpoint. Moreover, the TDD, FDD, and CDD techniques may be combined. In other words, the automated endpoint configuration module 109 may simultaneously use one or more of these techniques to determine the distance. Additionally, the collaboration endpoints 102(a), 102(b) may determine a speed of sound by dividing a known distance between a speaker and a microphone by the time it takes for sound to travel to increase the accuracy of the determined distance.

One advantage of using the FDD or CDD techniques instead of the TDD technique is that the FDD and CDD techniques are generally faster because the round trip distances are measured in succession in TDD techniques. In contrast, in the FDD and CDD techniques, the round trip distances may be measured simultaneously.

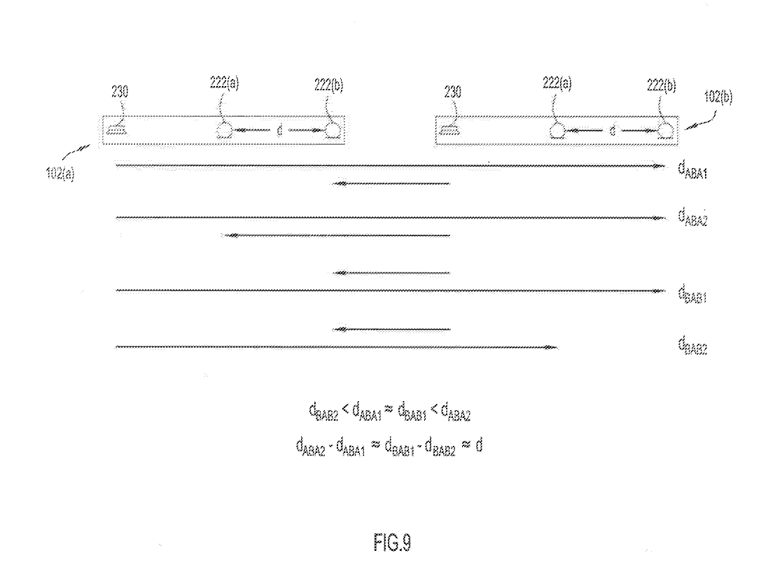

After these distances have been determined, the automated endpoint configuration module 109 may determine the relative positions of the two collaboration endpoints 102(a), 102(b). For example, the automated endpoint configuration module 109 may use the distance determinations to determine the relative positions. FIGS. 9-12B illustrate further details of techniques for determining a relative orientation of the collaboration endpoints 102(a), 102(b).

Referring first to FIG. 9, shown is a schematic diagram illustrating two collaboration endpoints 102(a), 102(b) positioned within the predetermined relative proximity, according to an example embodiment. Collaboration endpoint 102(a) includes a display screen (not shown), speaker 230, first microphone 222(a), and second microphone 222(b). Collaboration endpoint 102(b) includes a display screen (not shown), speaker 230, first microphone 222(a), and second microphone 222(b). In this positioning, collaboration endpoint 102(a) is substantially parallel and to the left of collaboration endpoint 102(b). Any number of distances may be used to determine the relative positioning. In this example, the automated endpoint configuration module 109 uses four distances to determine the position of the collaboration endpoints 102(a), 102(b) relative to each other. The four distances may be determined according to the methods described above in FIGS. 7A-7D and 8A-8D. One distance (d_{ABA1}) the automated endpoint configuration module 109 may use is the sum of the distances from the speaker 230 of collaboration endpoint 102(a) to the rightmost microphone 222(b) of collaboration endpoint 102(b) and from the speaker 230 of collaboration endpoint 102(b) to the rightmost microphone 222(b) of collaboration endpoint 102(a). Another distance (d_{ABA2}) the automated endpoint configuration module 109 may use is the sum of the distances from the speaker 230 of collaboration endpoint 102(a) to the rightmost microphone 222(b) of collaboration endpoint 102(b) and from the speaker 230 of collaboration endpoint 102(b) to the leftmost microphone 222(a) of collaboration endpoint 102(a). A third distance (d_{BAB1}) the automated endpoint configuration module 109 may use is the sum of the distances from the speaker 230 of collaboration endpoint 102(b) to the rightmost microphone 222(b) of collaboration endpoint 102(a) and from the speaker 230 of collaboration endpoint 102(a) to the rightmost microphone 222(b) of collaboration endpoint 102(b). A fourth distance (d_{BAB2}) the automated endpoint configuration module 109 may use is the sum of the distances from the speaker 230 of collaboration endpoint 102(b) to the rightmost microphone 222(b) of collaboration endpoint 102(a) and from the speaker 230 of collaboration endpoint 102(a) to the leftmost microphone 222(a) of collaboration endpoint 102(b).

The automated endpoint configuration module 109 may use these distances to determine the relative position of the collaboration endpoints 102(a), 102(b). In this example, collaboration endpoint 102(a) is parallel and to the left of collaboration endpoint 102(b). In this positioning, d_{ABA1} is similar to d_{BAB1}. Additionally, d_{ABA1} and d_{BAB1} are larger than d_{BAB2} but smaller than d_{ABA2}. Moreover, the difference between d_{ABA2} and d_{ABA1} is similar to the difference between d_{BAB1} and d_{BAB2}. The two differences are similar to a distance d between the microphones 222(a), 222(b) of collaboration endpoint 102(a) and between microphones 222(a), 222(b) of collaboration endpoint 102(b). When these distance relationships exist for the collaboration endpoints 102(a), 102(b), the automated endpoint configuration module 109 may determine that collaboration endpoint 102(a) is left of and parallel to collaboration endpoint 102(b). The automated endpoint configuration module 109 may then configure the display screens 114(a), 114(b) of the collaboration endpoints 102(a), 102(b) accordingly and as described above. The server 104 may then transmit this configuration to the collaboration endpoints 102(a), 102(b), where the automated configuration agents 234 234 running on the collaboration endpoints 102(a), 102(b) may configure the collaboration endpoints 102(a), 102(b) based on the configuration.

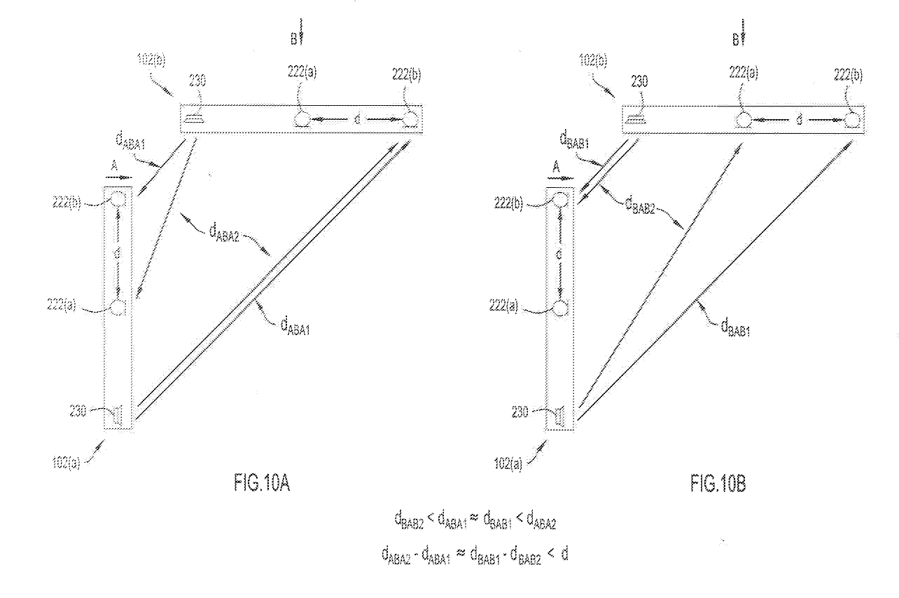

Turning to FIGS. 10A and 10B, shown are schematic diagrams illustrating two collaboration endpoints 102(a), 102(b) positioned within the predetermined relative proximity, according to an example embodiment. FIG. 10A illustrates the distances d_{ABA1} and d_{ABA2} while FIG. 10B illustrates the distances d_{BAB1} and d_{BAB2}. The distances d_{ABA1}, d_{ABA2}, and d_{BAB2} measure the same distances as described above with reference to FIG. 9. The automated endpoint configuration module 109 may use these distances to determine the relative position of the collaboration endpoints 102(a), 102(b). In this example, collaboration endpoint 102(a) is orthogonal to collaboration endpoint 102(b). In this positioning, d_{ABA1} is similar to d_{BAB1}. Additionally, d_{ABA1} and d_{BAB1} are greater than d_{BAB2} but smaller than d_{ABA2}. Also, the difference between d_{ABA2} and d_{ABA1} is similar to the difference between d_{BAB1} and d_{BAB2}. The two differences are both smaller than d, the distance between the microphones 222(a), 222(b) of collaboration endpoint 102(a) and between microphones 222(a), 222(b) of collaboration endpoint 102(b). When these distance relationships exist for the collaboration endpoints 102(a), 102(b), the automated endpoint configuration module 109 may determine that the collaboration endpoints 102(a), 102(b) are orthogonal to each other. The automated endpoint configuration module 109 may then configure the display screens 114(a), 114(b) of the collaboration endpoints 102(a), 102(b) accordingly and as described above. The server 104 may then transmit this configuration to the collaboration endpoints 102(a), 102(b), where the automated configuration agents 234 running on the collaboration endpoints 102(a), 102(b) may configure the collaboration endpoints 102(a), 102(b) based on the configuration.

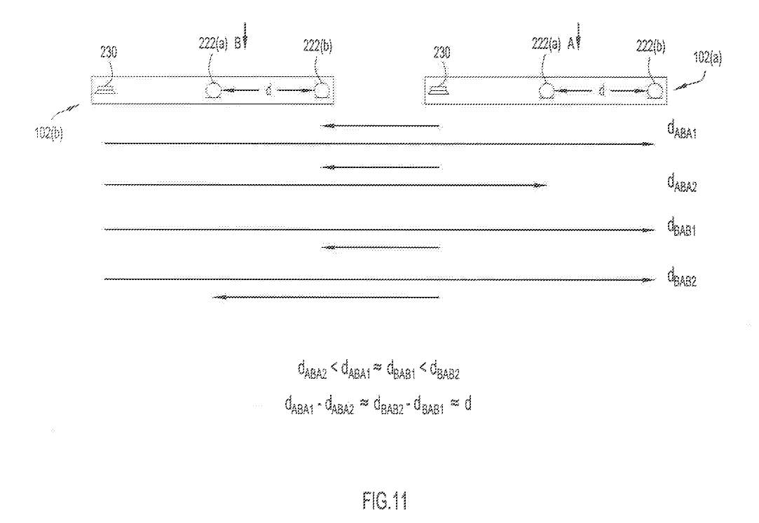

Turning next to FIG. 11, shown is a schematic diagram illustrating two collaboration endpoints 102(a), 102(b) positioned within a predetermined relative proximity, according to an example embodiment. FIG. 11 is similar to FIG. 9 except that collaboration endpoint 102(b) is now to the left of collaboration endpoint 102(a). The distances d_{ABA1}, d_{ABA2}, d_{BAB1}, and d_{BAB2} measure the same distances as described above with reference to FIG. 9. The automated endpoint configuration module 109 may use these distances to determine the relative position of the collaboration endpoints 102(a), 102(b). In this example, collaboration endpoint 102(b) is parallel to and left of collaboration endpoint 102(a). In this positioning, d_{ABA1} is similar to d_{BAB1}. Also, d_{ABA1} and d_{BAB1} is greater than d_{ABA2} but smaller than d_{BAB2}. Additionally, the difference between d_{ABA1} and d_{ABA2} is similar to the difference between d_{BAB2} and d_{BAB1}. Both of these differences are similar to d, the distance between the microphones 222(a), 222(b) of collaboration endpoint 102(a) and between microphones 222(a), 222(b) of collaboration endpoint 102(b). When these distance relationships exist for the collaboration endpoints 102(a), 102(b), the automated endpoint configuration module 109 may determine that collaboration endpoint 102(b) is substantially parallel to and left of collaboration endpoint 102(a). The automated endpoint configuration module 109 may then configure the display screens 114(a), 114(b) of the collaboration endpoints 102(a), 102(b) accordingly and as described above. The server 104 may then transmit this configuration to the collaboration endpoints 102(a), 102(b), where the automated configuration agents 234 running on the collaboration endpoints may configure the collaboration endpoints 102(a), 102(b) based on the configuration.

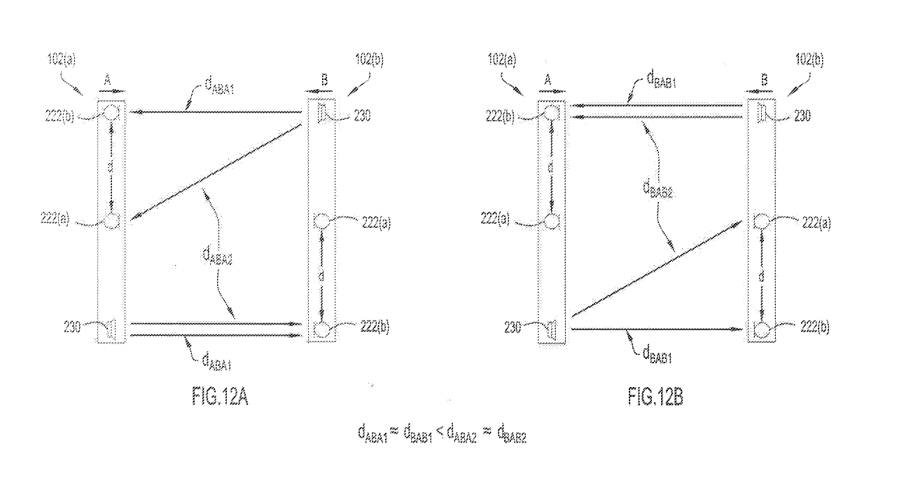

Turning to FIGS. 12A and 12B, shown are schematic diagrams illustrating two collaboration endpoints 102(a), 102(b) positioned within a predetermined relative proximity, according to an example embodiment. The distances d_{ABA1}, d_{ABA2}, d_{BAB1}, and d_{BAB2} measure the same distances as described above with reference to FIG. 9. The automated endpoint configuration module 109 may use these distances to determine the relative position of the collaboration endpoints 102(a), 102(b). In this example, collaboration endpoint 102(a) is facing collaboration endpoint 102(b). In this positioning, d_{ABA1} is similar to d_{BAB1} and d_{ABA2} is similar to d_{BAB2}. Additionally, d_{ABA2} is larger than d_{ABA1}. When these distance relationships exist for the collaboration endpoints 102(a), 102(b), the automated endpoint configuration module 109 may determine that the collaboration endpoints 102(a), 102(b) are substantially parallel to and facing each other. The automated endpoint configuration module 109 may then configure the display screens 114(a), 114(b) of the collaboration endpoints 102(a), 102(b) accordingly and as described above. The server 104 may then transmit this configuration to the collaboration endpoints 102(a), 102(b), where the automated configuration agents 234(a), 234(b) may configure the collaboration endpoints 102(a), 102(b) based on the configuration.

Alternatively, instead of, or in addition to, using the round trip time determinations to determine the relative positions of the collaboration endpoints 102(a), 102(b), the system 100 may use impulse radio ultra-wideband (IR-UWB) technology as described below.

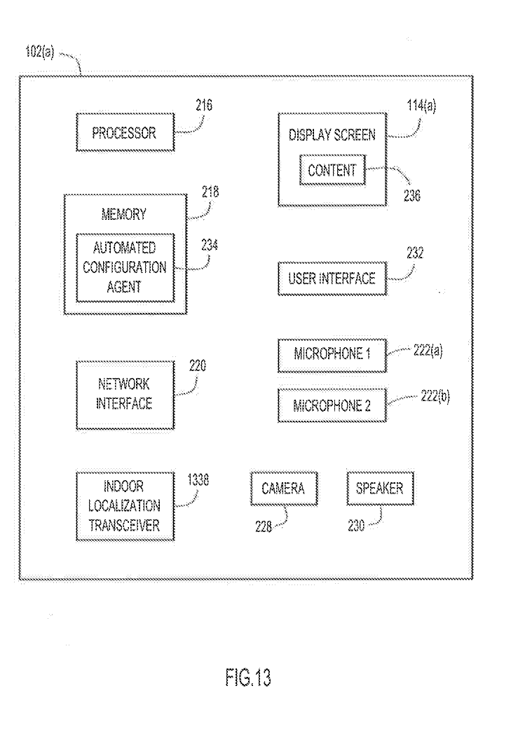

Turning next to FIG. 13, shown is a block diagram of collaboration endpoint 102(a) including an indoor localization transceiver 1338, according to an example embodiment. The block diagram of FIG. 13 is similar to the block diagram of FIG. 2. However, FIG. 13 shows that the collaboration endpoint further includes the indoor localization transceiver 1338. Although FIG. 13 only illustrates a configuration for collaboration endpoint 102(a), it is to be appreciated that collaboration endpoint 102(b) may have a similar configuration. As such, the details of collaboration endpoint 102(b) have been omitted from the description. Because the descriptions of FIGS. 2 and 13 are similar, this description of FIG. 13 will focus on the indoor localization transceiver 1338. In this aspect, the collaboration endpoint 102(a) may use indoor localization transceiver 1338 to determine a position of the first collaboration endpoint 102(a) with respect to other collaboration endpoints, such as collaboration endpoint 102(b). Indoor localization transceiver 1338 may use IR-UWB technology. However, any technology that enables determining a position of the first collaboration endpoint 102(a) with respect to the second collaboration endpoint 102(b) may be used. In one aspect, collaboration endpoint 102(a) may include four indoor localization transceivers 1338. For example, there may be an indoor localization transceiver 1338 at two corners of the collaboration endpoint 102(a). A third indoor localization transceiver 1338 may be centered at the bottom of the display screen 114(a). A fourth indoor localization transceiver 1338 may be positioned behind the display screen 114(a) to determine when the collaboration endpoints 102(a), 102(b) are facing each other or are back-to-back. It should be appreciated that any number of indoor localization transceivers 1338 may be used. It should also be appreciated that the indoor localization transceivers 1338 may be positioned in any suitable location within or on the collaboration endpoint 102(a).

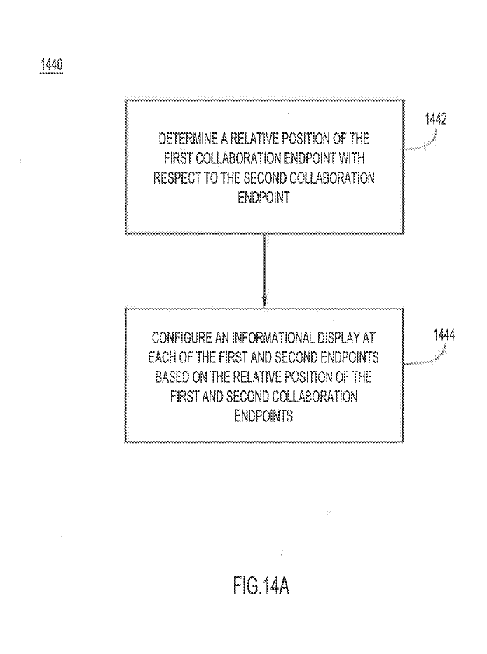

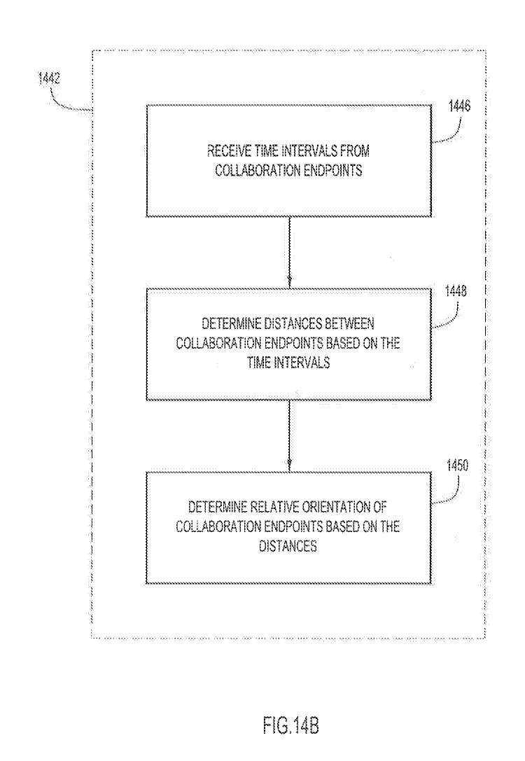

Turning to FIG. 14A, illustrated is a high-level flowchart of a method 1440 to carry out the techniques presented herein, according to an example embodiment. The method 1440 begins at operation 1442. At operation 1442, the automated endpoint configuration module 109 may determine a relative position of the first and second collaboration endpoints 102(a), 102(b). After operation 1442 is completed, the method 1440 proceed to operation 1444.

At operation 1444, the automated endpoint configuration module 109 may configure the display screens 114(a), 114(b) for each of the collaboration endpoints 102(a), 102(b) based on the determined relative positions of the first and second collaboration endpoints 102(a), 102(b). Additionally, the automated endpoint configuration module 109 may determine a configuration of content 236 to be displayed on display screens 114(a), 114(b). The server 104 may then transmit the configuration of content 236 to the collaboration endpoints 102(a), 102(b). After operation 1444 is completed, the method 1440 ends.

Turning to FIG. 14B, illustrated is a more detailed flowchart of operation 1442, according to an example embodiment. For example, operation 1442 may begin at operation 1446. At operation 1446, the automated endpoint configuration module 109 may receive time intervals from the collaboration endpoints 102(a), 102(b). The time intervals may be determined as explained above with reference to FIGS. 7 and 8. After operation 1446 is completed, operation 1442 proceeds to operation 1448.

At operation 1448, the automated endpoint configuration module 109 may determine distances between the collaboration endpoints 102(a), 102(b) based on the time intervals. The distances may be determined as explained above. After operation 1448 is completed, operation 1442 proceeds to operation 1450.

At operation 1450, the automated endpoint configuration module 109 may determine the relative orientation of the collaboration endpoints 102(a), 102(b) based on the distances. The relative orientation may be determined as explained above with reference to FIGS. 9-12. After operation 1450 is completed, operation 1442 may end.

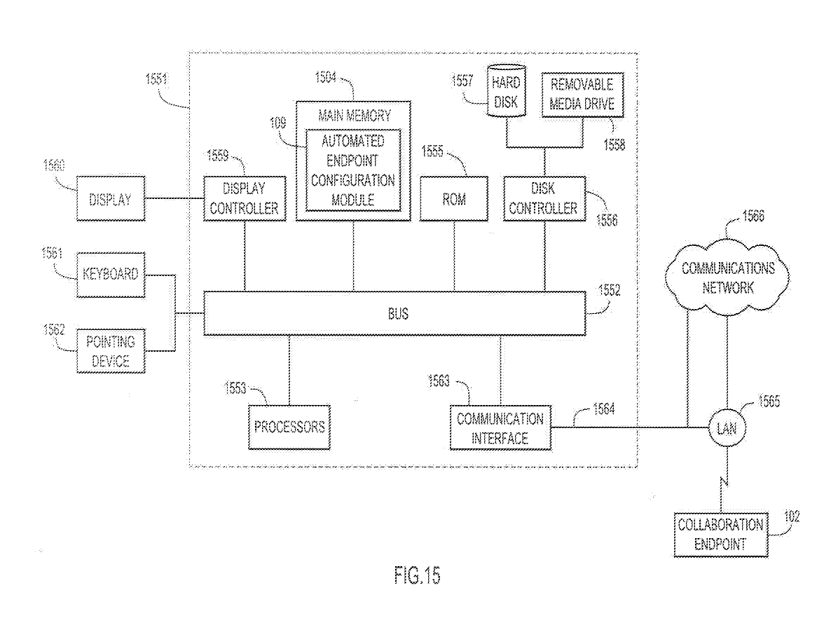

Turning to FIG. 15, shown is a block diagram of a computing device that may be representative of server 104 shown in FIG. 1, configured to perform the content and video distribution techniques, according to an example embodiment. FIG. 15 illustrates a computer system 1551 upon which the embodiments presented may be implemented. The computer system 1551 includes a bus 1552 or other communication mechanism for communicating information, and a processor 1553 coupled with the bus 1552 for processing the information. While the figure shows a single block 1553 for a processor, it should be understood that the processors 1553 represent a plurality of processing cores, each of which can perform separate processing. The computer system 1551 also includes a main memory 1554, such as a random access memory (RAM) or other dynamic storage device (e.g., dynamic RAM (DRAM), static RAM (SRAM), and synchronous DRAM (SD RAM)), coupled to the bus 1552 for storing information and instructions to be executed by processor 1553. In addition, the main memory 1554 may be used for storing temporary variables or other intermediate information during the execution of instructions by the processor 1553. Moreover, the main memory 1554 may also be used for storing the automated endpoint configuration module 109, which may be executed by the processor 1553.

The computer system 1551 further includes a read only memory (ROM) 1555 or other static storage device (e.g., programmable ROM (PROM), erasable PROM (EPROM), and electrically erasable PROM (EEPROM)) coupled to the bus 1552 for storing static information and instructions for the processor 1553.

The computer system 1551 also includes a disk controller 1556 coupled to the bus 1552 to control one or more storage devices for storing information and instructions, such as a magnetic hard disk 1557, and a removable media drive 1558 (e.g., floppy disk drive, read-only compact disc drive, read/write compact disc drive, compact disc jukebox, tape drive, and removable magneto-optical drive). The storage devices may be added to the computer system 1551 using an appropriate device interface (e.g., small computer system interface (SCSI), integrated device electronics (IDE), enhanced-IDE (E-IDE), direct memory access (DMA), or ultra-DMA).

The computer system 1551 may also include special purpose logic devices (e.g., application specific integrated circuits (ASICs)) or configurable logic devices (e.g., programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 1551 may also include a display controller 1559 coupled to the bus 1552 to control a display 1560, such as a liquid crystal display (LCD), light emitting diode (LED) display, for displaying information to a computer user. The computer system 1551 includes input devices, such as a keyboard 1561 and a pointing device 1562, for interacting with a computer user and providing information to the processor 1553. The pointing device 1562, for example, may be a mouse, a trackball, or a pointing stick for communicating direction information and command selections to the processor 1553 and for controlling cursor movement on the display 1560.

The computer system 1551 performs a portion or all of the processing steps of the process in response to the processor 1553 executing one or more sequences of one or more instructions contained in a memory, such as the main memory 1554. Such instructions may be read into the main memory 1554 from another computer readable medium, such as a hard disk 1557 or a removable media drive 1558. One or more processors in a multi-processing arrangement may also be employed to execute the sequences of instructions contained in main memory 1554. In alternative embodiments, hard-wired circuitry may be used in place of or in combination with software instructions. Thus, embodiments are not limited to any specific combination of hardware circuitry and software.

As stated above, the computer system 1551 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 1551, for driving a device or devices for implementing the process, and for enabling the computer system 1551 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 1551 also includes a communication interface 1563 coupled to the bus 1552. The communication interface 1563 provides a two-way data communication coupling to a network link 1564 that is connected to, for example, a local area network (LAN) 1565, or to another communications network 1566 such as the Internet. For example, the communication interface 1563 may be a wired or wireless network interface card to attach to any packet switched (wired or wireless) LAN. As another example, the communication interface 1563 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1563 sends and receives electrical, electromagnetic or optical signals that carry digital data streams representing various types of information.

The network link 1564 typically provides data communication through one or more networks to other data devices. For example, the network link 1564 may provide a connection to another computer through a local area network 1565 (e.g., a LAN) or through equipment operated by a service provider, which provides communication services through a communications network 1566. The local network 1564 and the communications network 1566 use, for example, electrical, electromagnetic, or optical signals that carry digital data streams, and the associated physical layer (e.g., CAT 5 cable, coaxial cable, optical fiber, etc.). The signals through the various networks and the signals on the network link 1564 and through the communication interface 1563, which carry the digital data to and from the computer system 1551 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1551 can transmit and receive data, including program code, through the network(s) 1565 and 1566, the network link 1564 and the communication interface 1563. Moreover, the network link 1564 may provide a connection through a LAN 1565 to a collaboration endpoint 102 such as a video conferencing system, personal digital assistant (PDA) laptop computer, or cellular telephone.

In one aspect of this disclosure, a computer-implemented method comprising: at a server in communication with at least first and second collaboration endpoints each located within a same physical space: determining a relative positioning of the first and second collaboration endpoints; and configuring content displayed at each of the first and second endpoints based on the relative positioning of the first and second collaboration endpoints is disclosed.

In another aspect of this disclosure, an apparatus comprising: a communication interface configured to enable network communications; a processor coupled with the communication interface to communicate with at least first and second collaboration endpoints each located within a same physical space, and configured to: determine a relative positioning of the first and second collaboration endpoints; and configure content displayed at each of the first and second endpoints based on the relative positioning of the first and second collaboration endpoint is disclosed.

In yet another aspect, a non-transitory computer-readable storage media encoded with software comprising computer executable instructions and when the software is executed by a processor, the processor is caused to: determine a relative positioning of first and second collaboration endpoints located in a same physical space; and configure content displayed at each of the first and second endpoints based on the relative positioning of the first and second collaboration endpoints is disclosed.

In one aspect of this disclosure, the method may determine a relative distance between at least one portion of the first collaboration endpoint and at least one portion of the second collaboration endpoint and determine a relative orientation between the first and second collaboration endpoints.

In another example embodiment, the method may configure the display screens of the first and second collaboration endpoints to operate as a combined display screen when the first and second collaboration endpoints are positioned within a predetermined relative proximity.

In yet another example, the method may determine a proximity of one or more persons relative to at least one of the first and second collaboration endpoints and based on the proximity of one or more poisons relative to at least one of the first and second collaboration endpoints and configure one of the first or second collaboration endpoints as a primary collaboration endpoint that displays content related to a user interaction.

In yet another aspect of this disclosure, when the first and second collaboration endpoints are determined to be oriented substantially orthogonal to each other and are within the predetermined relative proximity, the method may determine a proximity of one or more persons relative to at least one of the first and second collaboration endpoints, select the display screen of the first or second collaboration endpoint to display new or updated content based on the determined location of the one or more persons, and configure the selected display screen to display the new or updated content.

In another example, the method may configure the display screen of the first collaboration endpoint to display at least one remote collaboration participant, and configure the display screen of the second collaboration endpoint to display at least one remote collaboration presenter.

In another aspect, the method may determine that the first and second collaboration endpoints have been moved to relative positions in which the first and second collaboration endpoints are outside of a predetermined relative proximity, and prompt a person to dissociate the display screens of the first and second collaboration endpoints.

In yet another aspect, the method may configure the display screens of the first and second collaboration endpoints as two dissociated displays when the first and second collaboration endpoints are positioned outside of a predetermined relative proximity to one another.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
at a server in communication with at least first and second collaboration endpoints each located within a same physical space:
determining a relative positioning of the first and second collaboration endpoints; and
configuring content displayed at each of the first and second collaboration endpoints based on the relative positioning of the first and second collaboration endpoints.

2. The computer-implemented method of claim 1, wherein determining a relative positioning of the first and second collaboration endpoints comprises:
determining a relative distance between at least one portion of the first collaboration endpoint and at least one portion of the second collaboration endpoint; and
determining a relative orientation of the first and second collaboration endpoints.

3. The computer-implemented method of claim 1, wherein configuring content displayed at each of the first and second collaboration endpoints based on the relative positioning of the first and second collaboration endpoints, comprises:
configuring display screens of the first and second collaboration endpoints to operate as a combined display screen when the first and second collaboration endpoints are positioned within a predetermined relative proximity.

4. The computer-implemented method of claim 3, further comprising:
determining a proximity of one or more persons relative to at least one of the first and second collaboration endpoints; and
based on the proximity of one or more persons relative to at least one of the first and second collaboration endpoints, configuring one of the first or second collaboration endpoints as a primary collaboration endpoint that displays content related to a user interaction.

5. The computer-implemented method of claim 3, wherein when the first and second collaboration endpoints are determined to be oriented substantially orthogonal to each other and are within the predetermined relative proximity, configuring content displayed at each of the first and second collaboration endpoints based on the relative positioning of the first and second collaboration endpoints comprises:
determining a proximity of one or more persons relative to at least one of the first and second collaboration endpoints;
selecting the display screens of the first or second collaboration endpoint to display new or updated content based on the determined location of the one or more persons; and
configuring the selected display screen to display the new or updated content.

6. The computer-implemented method of claim 3, wherein configuring content displayed at each of the first and second collaboration endpoints based on the relative positioning of the first and second collaboration endpoints, comprises:
configuring the display screen of the first collaboration endpoint to display at least one remote collaboration participant; and
configuring the display screen of the second collaboration endpoint to display at least one remote collaboration presenter.

7. The computer-implemented method of claim 3, wherein configuring content displayed at each of the first and second collaboration endpoints based on the relative positioning of the first and second collaboration endpoints, comprises:
determining that the first and second collaboration endpoints have been moved to positions in which the first and second collaboration endpoints are outside of a predetermined relative proximity; and
prompting a person to dissociate the display screens of the first and second collaboration endpoints.

8. The computer-implemented method of claim 1, wherein configuring content displayed at each of the first and second collaboration endpoints based on the relative positioning of the first and second collaboration endpoints, comprises:
configuring display screens of the first and second collaboration endpoints as two dissociated displays when the first and second collaboration endpoints are positioned outside of a predetermined relative proximity.

9. An apparatus comprising:
a communication interface configured to enable network communications;
a processor coupled with the communication interface to communicate with at least first and second collaboration endpoints each located within a same physical space, the processor configured to:
determine a relative positioning of the first and second collaboration endpoints; and
configure content displayed at each of the first and second endpoints based on the relative positioning of the first and second collaboration endpoints.

10. The apparatus of claim 9, wherein the processor is configured to:
determine a relative distance between at least one portion of the first collaboration endpoint and at least one portion of the second collaboration endpoint; and
determine a relative orientation of the first and second collaboration endpoints.

11. The apparatus of claim 9, wherein, the processor is further configured to:
configure the display screens of the first and second collaboration endpoints to operate as a combined display screen when the first and second collaboration endpoints are positioned within a predetermined relative proximity.

12. The apparatus of claim 11, wherein the processor is further configured to:
determine a proximity of one or more persons relative to at least one of the first and second collaboration endpoints; and
based on the proximity of one or more persons relative to at least one of the first and second collaboration endpoints, configure one of the first or second collaboration endpoints as a primary collaboration endpoint that displays content related to a user interaction.

13. The apparatus of claim 11, wherein when the first and second collaboration endpoints are determined to be oriented substantially orthogonal to each other and are within the predetermined proximity to one another, the processor is further configured to:
determine a proximity of one or more persons relative to at least one of the first and second collaboration endpoints;
select the display screens of the first or second collaboration endpoint to display new or updated content based on the determined location of the one or more persons; and
configure the selected display screen to display the new or updated content.

14. The apparatus of claim 11, wherein the processor is configured to:
configure the display screen of the first collaboration endpoint to display at least one remote collaboration participant; and
configure the display screen of the second collaboration endpoint to display at least one remote collaboration presenter.

15. The apparatus of claim 11, wherein the processor is configured to:
determine that the first and second collaboration endpoints have been moved to relative positions in which the first and second collaboration endpoints are outside of a predetermined relative proximity; and
prompt a person to dissociate the display screens of the first and second collaboration endpoints.

16. The apparatus of claim 9, wherein the processor is configured to:
configure the display screens of the first and second collaboration endpoints as two dissociated displays when the first and second collaboration endpoints are positioned outside of a predetermined relative proximity.

17. A non-transitory computer-readable storage media encoded with software comprising computer executable instructions and when the software is executed by a processor, the processor is caused to:
determine a relative positioning of a first and second collaboration endpoints located within a same physical space; and
configure content displayed at each of the first and second endpoints based on the relative positioning of the first and second collaboration endpoints.

18. The non-transitory computer-readable storage media encoded with software of claim 17, wherein the instructions caused the processor to:
determine a relative distance between at least one portion of the first collaboration endpoint and at least one portion of the second collaboration endpoint; and
determine a relative orientation between the first and second collaboration endpoints.

19. The non-transitory computer-readable storage media encoded with software of claim 17, wherein the instructions cause the processor to:
configure the display screens of the first and second collaboration endpoints to operate as a combined display screen when the first and second collaboration endpoints are positioned within a predetermined relative proximity.

20. The non-transitory computer-readable storage media encoded with software of claim 19, wherein the instructions cause the processor to:
determine a proximity of one or more persons relative to the first and second collaboration endpoints; and
based on the proximity of one or more persons relative to the first and second collaboration endpoints, configure one of the first or second collaboration endpoints as a primary collaboration endpoint that displays content related to a user interaction.
